(19) United States
(12) Patent Application Publication
(10) Pub. No.: US 2026/0100847 A1
(43) Pub. Date: Apr. 9, 2026

(54) WEB TOKENS FOR AUTHENTICATION OF DATA LAKE FILES

(71) Applicant: SAP SE, Walldorf (DE)

(72) Inventors: Johannes Alberti, Walnut Creek, CA (US); Felipe Einsfeld Kersting, Rio Grande do Sul (BR)

(21) Appl. No.: 18/944,845

(22) Filed: Nov. 12, 2024

Related U.S. Application Data
(60) Provisional application No. 63/703,556, filed on Oct. 4, 2024.

(51) Int. Cl. H04L 9/32; G06F 21/62

(52) U.S. Cl. CPC H04L 9/3247; G06F 21/6209; H04L 9/3213; H04L 9/3265; G06F 2221/2141

(57) ABSTRACT

In an example embodiment, data lake files are enhanced to support authentication and authorization via web tokens. Furthermore, the web tokens may be dynamic. Different types of web tokens can be introduced to accomplish different goals. The authentication rules can be integrated into the tokens themselves. This greatly improves scalability based on the richness of a resource system.

### CROSS-REFERENCE TO RELATED APPLICATIONS

This application claims the benefit of U.S. Provisional Application No. 63/703,556, filed Oct. 4, 2024, entitled “WEB TOKENS FOR AUTHENTICATION OF DATA LAKE FILES,” which is incorporated herein by reference in its entirety.

### BACKGROUND

A data lake is a single, centralized repository where an organization can store data in structured, unstructured, and semi-structured format. This allows an organization to more quickly and easily store, access, and analyze a wide variety of data in a single location. Unlike a database, data stored in a data lake does not need to fit into a specific structural format. Instead, data can be stored in its raw or native format, usually as files or binary large objects (BLOBS).

### BRIEF DESCRIPTION OF DRAWINGS

The present disclosure is illustrated by way of example and not limitation in the figures of the accompanying drawings, in which like references indicate similar elements.

FIG. 1 is a block diagram illustrating a system for HDL file management, in accordance with a first example embodiment.

FIG. 2 is a block diagram illustrating the system for HDL file management, in accordance with a second example embodiment.

FIG. 3 is a flow diagram illustrating a method for authenticating a user of a data lake, in accordance with an example embodiment.

FIG. 4 is a block diagram illustrating a software architecture, which can be installed on any one or more of the devices described above.

FIG. 5 illustrates a diagrammatic representation of a machine in the form of a computer system within which a set of instructions may be executed for causing the machine to perform any one or more of the methodologies discussed herein.

### DETAILED DESCRIPTION

The description that follows discusses illustrative systems, methods, techniques, instruction sequences, and computing machine program products. In the following description, for purposes of explanation, numerous specific details are set forth in order to provide an understanding of various example embodiments of the present subject matter. It will be evident, however, to those skilled in the art, that various example embodiments of the present subject matter may be practiced without these specific details.

Files in a data lake may be stored in a data lake storage format. Data lake files can also sometime be stored in an in-memory data store, such as HANA™ from SAP of Walldorf, Germany. A format used to store data lake files is therefore known as HANA Data Lake (HDL) format.

Security of access to HDL files is an area of concern. Without appropriate access control capabilities, malicious users may gain access to sensitive data stored in HDL files in a data lake. This access control typically involves the use of an authentication system, which authenticates that a user is who they claim to be and then verifies that the user has a role that corresponds to a role that has been granted access to a particular HDL file.

Currently HDL file authentication relies on a cluster file container (CFC) using client certificates, and specifically x509 client certificates. A CFC is Kubernetes custom resource definition that allows an abstraction between the underlying hyperscalar storage device and the user.

x509 certificates are a standard format for public key certificates used in various security protocols to establish secure communications and verify identities. They are a fundamental part of public key infrastructure (PKI) and are widely used for securing web traffic, email, and other forms of communication.

An x509 certificate typically contains the following components:
1. Version: Indicates the version of the X.509 standard used (e.g., X.509 v3).
2. Serial Number: A unique identifier assigned to the certificate by the certificate authority (CA).
3. Signature Algorithm: The algorithm used to sign the certificate (e.g., SHA256 with RSA).
4. Issuer: The entity that issued and signed the certificate, usually a certificate authority (CA).
5. Validity Period: The timeframe during which the certificate is valid, including a start date and an expiration date.
6. Subject: The entity to which the certificate is issued, such as a domain name or an individual's name.
7. Public Key: The public key associated with the certificate. This key is used for encryption and verifying digital signatures.
8. Extensions: Additional fields that provide extra information or capabilities, such as key usage, extended key usage, and subject alternative names.

Each CFC has a declared list of x509 trusts and user requests are only authenticated if they are performed with trusted client certificates in the context of the CFC being accessed. HDL Files authenticated users are bound to a set of roles, and each role gives the user a set of privileges. Users are only authorized to access a given resource if they have enough privileges to do so. The definition of the roles is part of the CFC definition (CFC CR). The CFC definition also contains authorization records, which are rules that bind user identities to a set of roles.

The richer a resource system becomes, however, the more aware the authorization system needs to be of the richness, otherwise it does not even know the tasks it can assign the authorization rules to.

A technical problem is encountered, however, when scaling up the authorization system based on the richness of the resource system. Specifically, at a certain point the policy system becomes a bottleneck, as the processing needed to manage the authentication policies becomes too burdensome for the system to perform within a reasonable amount of time, causing noticeable delays in HDL file access and management.

In an example embodiment, HDL files are enhanced to support authentication and authorization via web tokens. Furthermore, the web tokens may be dynamic. Different types of web tokens can be introduced to accomplish different goals. The authentication rules can be integrated into the tokens themselves. This greatly improves scalability based on the richness of a resource system.

In an example embodiment, a specific type of web token may be used. This type is known as JavaScript Object Notation Web Token (JWT). A JWT is made up of three parts, each separated by a dot (.):

| | |
|---|---|
| 1. | Header: Contains metadata about the token, such as the type of |
| | token (JWT) and the signing algorithm used (e.g., HMAC SHA256, |
| | RSA). |
| | Example: |
| | json |
| | Copy code |
| | { |
| | “alg”: “HS256”, |
| | “typ”: “JWT” |
| | } |
| | 2. Payload: Contains the claims, which are statements about an |
| | entity (typically, the user) and additional data. Claims can be of three |
| | types: |
| | a. Registered claims: Predefined claims like sub (subject), exp |
| | (expiration time), and iat (issued at). |
| | b. Public claims: Custom claims that can be defined by anyone, but |
| | they should be registered to avoid conflicts. |
| | c. Private claims: Custom claims created to share information |
| | between parties that agree on using them. |
| | Example: |
| | json |
| | Copy code |
| | { |
| | “sub”: “1234567890”, |
| | “name”: “John Doe”, |
| | “admin”: true |
| | } |
| | 6. Signature: Created by taking the encoded header and payload and |
| | signing it with a secret key (for HMAC algorithms) or a private key |
| | (for RSA algorithms). This ensures the token's integrity and |
| | authenticity. |
| | The signature is calculated as follows: |
| | scss |
| | Copy code |
| | HMACSHA256( |
| | base64UrlEncode(header) + “.” + |
| | base64UrlEncode(payload), |
| | secret) |

It should be noted that this disclosure will discuss the solution in terms of a JWT implementation. However, other types of web tokens are contemplated as well and nothing in this disclosure shall be interpreting as limiting the scope of coverage only to a JWT implementation, unless expressly claimed.

In an example embodiment, three different categories of JWTs are introduced that will be supported by HDL files. These categories include:
1. JWTs that are internally created by HDL files, distributed by HDL files, and used internally
2. JWTs that are created by authorized users of HDL files, following a format that is specific to HDL files
3. JWTs that come from identity providers that are not controlled by HDL files.

Category (1) comprises JWTs that are generated by HDL Files, signed by HDL Files' own material, and distributed to internal components. These JWTs are intended to be used solely to ease integration with other internal components and therefore their usage can be restricted to specific components. In this disclosure, these JWTs will be called internal JWTs.

Category (2) comprises JWTs that are generated by HDL Files users and signed by users' material. These JWTs can be especially useful for use-cases such as Delta Sharing, in which users with impersonation privileges can generate temporary credentials, in the form of a JWT, to allow recipients to access HDL Files. In this document, these JWTs will be called recipient JWTs.

Finally, category (3) comprises JWTs that are generated and managed by external identity providers. In this document, these JWTs will be called external JWTs.

Internal and recipient JWTs will follow the same format, which is defined by HDL Files. Overall, the format aims to represent JWTs as “dynamic transportable policies” according to the new policy design proposed in HDL Files Policies. This is an example of a HDL Files policy:

```
{
  “author”: “alice”,
    “createdAt”: 1475877193,
    “resources”: [
      “share:bobshare”
    ],
    “subjects”: [
      “user:bob”
    ],
    “privileges”: [
      “browse”,
      “open”
    ],
    “constraints”: [
      {
        “context”: “x509:subject”,
        “op”: “match”,
        “literal”: {
          “value”: “.*CN=bob.*”,
          “valueType”: “string”
        }
      }
    ]
}
```

A JWT is composed by headers, claims and a signature. HDL Files' JWT format specifies a list of valid claims where many of the claims have a direct correlation with the policy fields presented above.

The next sections focus on the general format of such JWTs.

The JWT will carry the x5c header containing the certificate chain that signed the JWT. This is to allow HDL Files to authenticate the issuer of the JWT and check their privileges within the system.

The following claims can be supported:

| Claim | Example | Description |
|---|---|---|
| iss | CN = [ . . . ] | The issuer of the JWT, it |
| | | must match the subject |
| | | of the client certificate |
| | | that signed the JWT. |
| sub | bob | The user represented by |
| | | the JWT. |
| aud | [instance-fqdn] | Indicates the HDL |
| | | instance in which this |
| | | JWT can be used. |
| exp | 1475878357 | Indicates the expiration |
| | | time of the token. |
| nbf | 1475877193 | Specifies the time before |
| | | which the token is not |
| | | valid. |
| iat | 1475877193 | Indicates the time at |
| | | which the token was |
| | | issued. |
| roles | [“role1”, “role2”] | Indicates the roles |
| | | assigned to the identity |
| | | represented by this JWT. |
| com.sap.bds/entitlements | See below | Privileges assigned for |
| | | the user for specific |
| | | resources. |
| com.sap.bds/constraints | See below | Constraints restricting the |
| | | JWT usage. |
| requestedPays | false | Indicates whether |
| | | requests performed by the |
| | | JWT must be charged. |

An example of a recipient JWT payload, which represents the same context as the policy previously shown, is:

```
{
  “iss”: “CN=alice,O=Alice Company”,
  “sub”: “bob”,
“aud”:
“fcac1d9f-d4f2-47a7-ae33-e22fb340b966.files.hdl.demo-hc-3-hdl-hc-
dev.dev-aws.hanacloud.ondemand.com”
  “exp”: 1475878357,
  “nbf”: 1475877193,
  “iat”: 1475877193,
  “com.sap.bds/entitlements”: [
    {
      “resources”: [“share:bobshare”],
      “privileges”: [“browse”, “open”]
    }
  ],
  “com.sap.bds/constraints”: [
    {
      “context”: “x509:subject”,
      “op”: “match”,
      “literal”: {
        “value”: “.*CN=bob.*”,
        “valueType”: “string”
      }
    }
  ]
}
```

The issuer claim indicates the identity that issued the JWT. The issuer may be the x509 subject of the certificate that signed the JWT, which will also be available in the x5c header.

The subject (sub) claim indicates the user that is being represented by the JWT. When the JWT is used in a request to HDL Files, the request context will be established assuming that the user performing the request is the subject of the JWT. For that, HDL Files will check if the issuer of the JWT does have enough privileges to impersonate the subject. If it does not, then the request will be unauthorized.

The subject claim is analogous to a field user:alice in the subjects array of an HDL Files policy.

The audience (aud) claim defines the specific HDL instance that the JWT can be used. The following format is used:

“aud”: “[instance-FQDN]”

For example:

aud”: “fcac1d9f-d4f2-47a7-ae33-e22fb340b966.files.hdl.demo-hc-3-hdl-hc-dev.dev-
aws.hanacloud.ondemand.com”

This will restrict the JWT to only be valid when used in the context of instance fcac1d9f-d4f2-47a7-ae33-e22fb340b966 on that landscape. Requests to any other instance or landscape will be rejected.

The roles claim indicates the roles assigned to the identity represented by the JWT. It is an array where each element is simply the name of the role scoped to a specific CFC, as a string Each role follows the format container:[container]:[role-name]. If container:[container] is omitted, the main CFC is considered as the container. For example: “roles”: [“role1”, “container:fcac1d9f-d4f2-47a7-ae33-e22fb340b966-sofres:role2”]

In the example, this JWT is granting the role role1 when it is used to access the main CFC of the instance. It is also granting the role role2 when it is used to access the specific instance's CFC fcac1d9f-d4f2-47a7-ae33-e22fb340b966-sofres.

Note that these roles will be considered when policies are evaluated. Note further that the issuer must have the AUTHORIZE privilege within the context of the referenced container, when granting roles.

If no roles are claimed, the JWT impersonates the user indicated in the sub claim, but no role is granted to the user for any established request. In this case, privileges would only be granted to the user by the means of static server policies that explicitly do so (or by explicit JWT entitlements, see below).

The entitlements claim defines the list of privileges that are granted to the user in the context of specific resources. If the entitlements claim is omitted, then the user does not receive any special privilege, i.e., it is equivalent as an empty entitlements array.

The resource key/value is analogous to the resources array of HDL Files' policies. In the JWT, it is composed by an optional container namespace and a mandatory resource namespace.

Note that if the roles claim is used together with this claim, then both are combined, that is, the user will be bound to a set of roles and, at the same time, will receive additional privileges.

The resource namespace specifies to which resource or group of resources the entitlement is valid.

The privileges array simply contains the list of privileges to be granted for the specific resource defined in the resource field of the entitlement.

The following are some JWT configuration examples and what they represent in practice:

| sub | roles | entitlements | description |
|---|---|---|---|
| Present | Empty/Omitted | Empty/Omitted | The JWT will impersonate the user |
| | | | declared in the sub claim. |
| | | | However, this user will have zero |
| | | | roles, and also no dynamic policies. |
| | | | This means that the user will only |
| | | | be able to access a resource if |
| | | | there are static server policies |
| | | | explicitly granting privileges to the user in |
| | | | the context of that resource. |
| | | | This is an impersonation-only JWT. |
| Present | Present | Empty/Omitted | The JWT will impersonate the user |
| | | | declared in the sub claim and the |
| | | | user will receive all roles declared in |
| | | | the roles claim. However, given |
| | | | that there are no com.sap.bds/entitlements, |
| | | | the JWT does not grant additional |
| | | | dynamic policies to the user. |
| Present | Empty/Omitted | Present | The JWT will impersonate the user |
| | | | declared in the sub claim and the |
| | | | JWT will grant additional dynamic |
| | | | policies to the user based on the |
| | | | com.sap.bds/entitlements claim. |
| | | | However, the user will have zero |
| | | | roles. This means that the user will |
| | | | only be able to access a resource if |
| | | | there are static server policies or |
| | | | dynamic JWT policies |
| | | | (entitlements) explicitly granting |
| | | | privileges to the user in the context |
| | | | of that resource. |
| Present | Present | Present | The JWT will impersonate the user |
| | | | declared in the sub claim, the user |
| | | | will receive all roles declared in the |
| | | | roles claim, and the JWT will |
| | | | grant additional dynamic policies to |
| | | | the user based on the |
| | | | com.sap.bds/entitlements claim. |

The constraints claim defines a list of constraints that impose certain restrictions to the JWT. For example, the following JWT payload imposes a constraint on the subject of the x509 client certificates that can transport this JWT via mTLS:

```
{
  “iss”: “CN=hdl-files-service,OU=hdl.demo-hc-3-hdl-hc-dev.dev-
aws.hanacloud.ondemand.co
  “sub”: “bob”,
“aud”:
“fcac1d9f-d4f2-47a7-ae33-e22fb340b966.files.hdl.demo-hc-3-hdl-hc-
dev.dev-aws.ha
  “exp”: 1475878357,
  “nbf”: 1475877193,
  “iat”: 1475877193,
  “com.sap.bds/entitlements”: [
    {
      “resources”: [“*”],
      “privileges”: [“browse”, “open”]
    }
  ],
  “com.sap.bds/constraints”: [
    {
      “context”: “x509:subject”,
      “op”: “match”,
      “literal”: {
        “value”: “.*CN=bob.*”,
        “valueType”: “string”
      }
    }
  ]
}
```

As already mentioned, the JWT represents a “dynamic transportable policy” that is given to the user identified by the subject claim. Therefore, the policy defined by the JWT can collide with static policies that are defined in the CFC.

If this happens, a set of rules to prioritize and aggregate all policies will be employed to resolve the conflict without ambiguity.

For example, the following JWT payload gives user Alice privileges to access all shares of a specific instance:

```
  “iss”: “CN=bob,O=Bob Company”,
  “sub”: “Alice”,
  “aud”:
  “z93c1d9f-d4f2-47a7-ae33-e22fb340b966.files.hdl.demo-hc-3-hdl-
hcdev.dev-aws.ha
  “exp”: 1475878357,
  “nbf”: 1475877193,
  “iat”: 1475877193,
  “com.sap.bds/entitlements”: [
{
      “resources”: [“share:*”],
      “privileges”: [“browse”, “open”]
    }
  ]
}
```

If this instance has a share named aliceshare, then, if no policies are in place, Alice would be able to access the share, as well as its underlying data, via HDL Files' sharing API.

If, however, the following policy is created in the main CFC of the instance:

```
{
  “author”: “bob”,
  “createdAt”: 1475877193,
  “resources”: [
    “share:aliceshare”
  ],
  “subjects”: [
    “user:*”
  ],
  “privileges”: [ ]
}
```

Then Alice would lose access to share aliceshare, given that the resource definition of this policy is more specific than the policy represented by the JWT.

However, if a new JWT was created with the following payload:

```
{
  “iss”: “CN=bob,O=Bob Company”,
  “sub”: “Alice”,
  “aud”:
  “z93c1d9f-d4f2-47a7-ae33-e22fb340b966.files.hdl.demo-hc-3-hdl-
hcdev.dev-aws.ha
  “exp”: 1475878357,
  “nbf”: 1475877193,
  “iat”: 1475877193,
  “com.sap.bds/entitlements”: [
    {
      “resources”: [“share:aliceshare”],
      “privileges”: [“browse”, “open”]
    }
  ]
}
```

Then Alice would have access to aliceshare again. This is because the policy represented by this JWT is bound to subject user:Alice, which is more specific than user:*

Internal JWTs and recipient JWTs have the exact same format, but internal JWTs are signed by HDL Files' own x509 key material, whereas recipient JWTs are signed by users' x509 key material. HDL Files will be able to differentiate between the two by analyzing the x5c header and checking if it contains its own certificate chain.

If the x5c header contains HDL Files' own certificate chain and the JWT has a valid signature, the claims of the JWT will be analyzed (exp, nbf, iat, iss) and, if they are all valid, the request will be authenticated.

If the x5c header does not contain HDL Files' own certificate chain, then the JWT is considered a recipient JWT. In this case, if the JWT has a valid signature and valid claims, HDL Files will extract the privileges of the issuer. This is done based on the provided certificate and according to the static authorization records in the CFC.

The JWT will only be accepted if the issuer has enough privileges to establish the context declared in the JWT.

All HDL Files APIs are exposed through endpoints that require mTLS authentication. This means that users will only be able to use JWTs over mTLS connections. The exception is HDL Files Delta Sharing-only endpoint, which will be introduced in the context of Delta Sharing.

For endpoints that are exposed through mTLS, the validation of the user client certificates will depend on whether internal JWTs or recipient JWTs are being used. If internal JWTs are being used, HDL Files will restrict connections solely to client certificates that are trusted by HDL Files internal trust store. This includes cluster certificates, such as the certificates that will be used by SoF workers.

If recipient JWTs are being used, HDL Files will restrict connections solely to client certificates that are trusted by the CFC-specific truststore (CFC CR .trusts section). Note that no privilege is required for the transport layer user, the only requirement is that the presented certificate is trusted by the CFC truststore.

In both cases, the certificate used in the transport layer is used solely as an extra authentication method. The user identity will be obtained from the JWT and not from the certificate used in transport.

In the case of regular TLS connections, no x509 client certificate is involved, so authentication and authorization is done solely based on the JWT.

Recipient JWTs can be revoked by the means of creating deny policies with the special jwt:iat constraint. This constraint is described in detail in HDL Files Policies—jwt:iat. For example, given that Bob created the following JWT for Alice:

```
{
  “iss”: “CN=bob,O=Bob Company”,
  “sub”: “Alice”,
  “aud”:
  “z93c1d9f-d4f2-47a7-ae33-e22fb340b966.files.hdl.demo-hc-3-hdl-
hcdev.dev-aws.ha
  “exp”: 1475897193,
  “nbf”: 1475877193,
  “iat”: 1475877193,
  “com.sap.bds/entitlements”: [
    {
      “resources”: [“share:aliceshare”],
      “privileges”: [“browse”, “open”]
    }
  ]
}
```

If this JWT is compromised, Bob can revoke it by defining a deny policy with the jwt:iat constraint, as follows:

```
{
  “type”: “deny”,
  “author”: “bob”,
  “createdAt”: 1475887193,
  “resources”: [
    “share:aliceshare”
  ],
  “subjects”: [
    “user:alice”
  ],
  “constraints”: [
    {
      “context”: “jwt:iat”,
      “op”: “smallerThan”,
      “literal”: {
        “value”: “1475877194”,
        “valueType”: “epoch”
      }
    }
  ]
}
```

Note that this policy defines the exact same resources/subjects as the JWT. It also has a constraint that comprises all JWTs whose iat claim is smaller than 1475877194.

Once this policy is created, when the original JWT is used, the deny policy will be activated and all user privileges will be revoked.

Also note that the resource/subject of the policy above could be more generic, and the policy would still revoke the JWT. For example, the same policy but with resources: [“share:*”] would not only revoke the JWT, but it would also revoke other JWTs created for Alice to access shares.

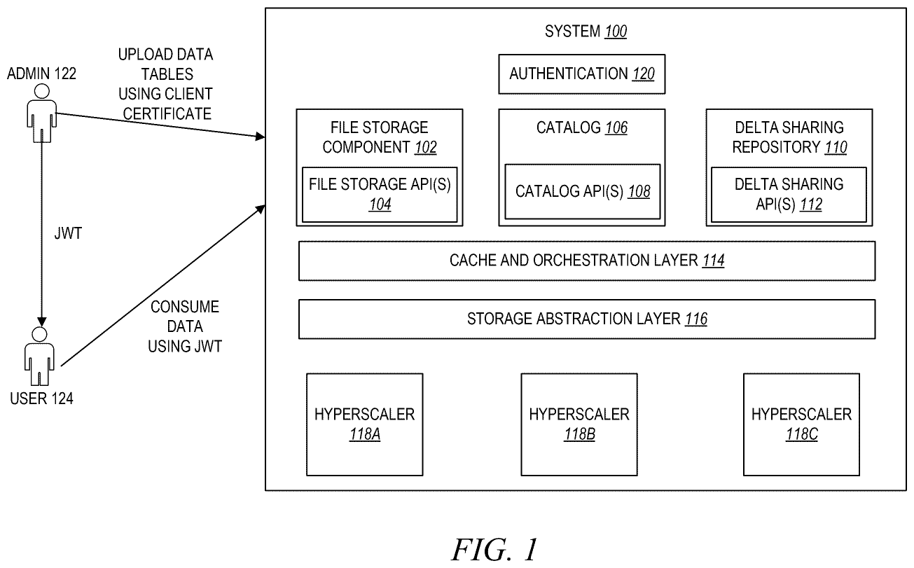

FIG. 1 is a block diagram illustrating a system 100 for HDL file management, in accordance with a first example embodiment. A file storage component 102 stores the HDL files themselves. The file storage component 102 may be in the form of, for example, a Web Hadoop Distributed File System (WebHDFS) repository or database. WebHDFS is a Representational State Transfer (REST) application program interface (API) for accessing HDFS files. It provides a web-based interface to interact with HDFS, allowing for file storage and retrieval operations over Hypertext Transfer Protocol (HTTP). The file storage component 102 may therefore have one or more file storage APIs 104, such as a WebHDFS, that can be used to access, upload, download, and manage the files stored in the file storage component 102.

A catalog 106 manages metadata relating to the HDL files, such as table definitions, schema information, and file attributes. This helps in organizing and querying metadata efficiently. The catalog 106 includes tables that describe the structure, relationships, and attributes of the HDL files. Querying and management of this metadata can be performed using one or more catalog APIs 108.

A delta sharing repository 110 stores information about delta shares. Delta sharing involves sharing incremental changes (deltas) between different versions of HDL files. The delta sharing repository 110 tracks these changes and facilitates efficient sharing. This may involve storing delta files or logs that capture modifications, additions, or deletions occurring between different versions of HDL files. The delta sharing repository 110 has one or more delta sharing APIs 112 to perform these tasks.

A cache and orchestration layer 114 manages interactions with the system 100 and the one or more file storage APIs 104, the one or more catalog APIs 108, and the one or more delta sharing APIs 112. More specifically it can cache frequently accessed HDL files, metadata, and delta tables and handles workflows, process automation, and ensures that data flows smoothly between the file storage component 102, the catalog 106, and the delta sharing repository 110.

A storage abstraction layer 116 offers a consistent API for interacting with different types of storage systems and hides the details of where and how the data is stored, allowing applications to interact with data in a uniform way regardless of the underlying storage technology. Thus, for example, external hyperscalers 118A, 118B, 118C can interact with the file storage component 102, the catalog 106, and the delta sharing repository 110 without knowing the details of how those components operate. The storage abstraction layer 116 abstracts the one or more file storage APIs 104, the one or more catalog APIs 108, and the one or more delta sharing APIs 112.

An authentication component 120 ensures that only authorized users and systems can access and modify the HDL files or metadata.

In this first example embodiment, an admin 122 uploads data tables to the system 100 using File APIs. This is done by the admin presenting an authenticated client certificate with enough privileges. This communication may be performed via, for example, a REST API or an HDL File Storage Command Line Interface (HDLFSCLI).

Then the admin 122 generates a JWT, signed by their authenticated and super-privileged identity to impersonate user 124 and grant, via entitlements, a restricted set of privileges that allows user 124 and only user 124 to read a specific share/table in the system 100. The admin 122 send this JWT to user 124, who is now able to consume the delta table using those limited privileges. Thus, the user 124 consumes the delta table using their preferred tool (e.g., Spark, Pandas), which authenticates and reads from the system 100. The tool is then also capable of processing the data.

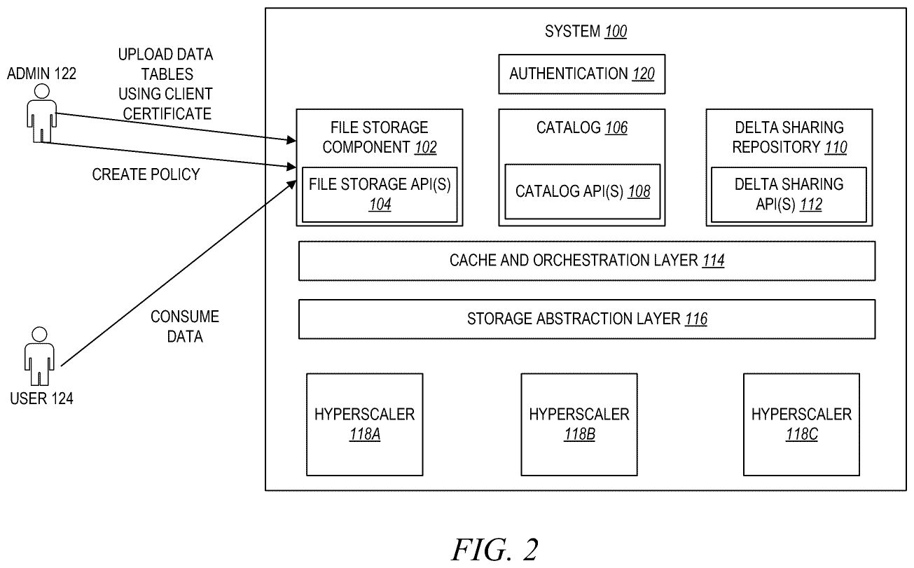

FIG. 2 is a block diagram illustrating the system 100 for HDL file management, in accordance with a second example embodiment. The architecture of FIG. 2 is identical to that of FIG. 1, although how the architecture is used by the admin 122 and the user 124 is different. Specifically, here the admin 122 (or a user/application) uploads data tables to the system 100 using File APIs. This is done by the admin presenting an authenticated client certificate with enough privileges. This communication may be performed via, for example, a REST API or an HDL File Storage Command Line Interface (HDLFSCLI).

The admin 122 (or user/application) then creates a policy in the system 100 allowing user 124 to access solely the uploaded delta tables. Then the user 124 consumes the data by authenticating to the system 100 using a client certificate identity.

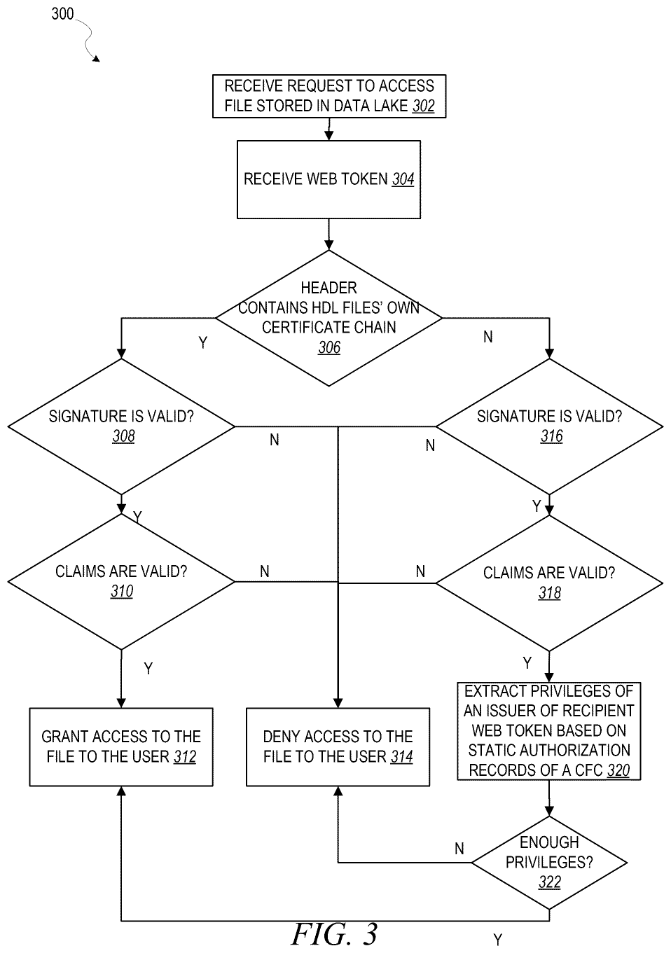

FIG. 3 is a flow diagram illustrating a method 300 for authenticating a user of a data lake, in accordance with an example embodiment. At operation 302, a request to access a file stored in a data lake is received. At operation 304, a web token associated with the user is received. The web token containing a header, a signature, and one or more claims. At operation 306, it is determined whether the header contains the certificate chain of a data lake file management software, such as HDL Files. If so, then at operation 308 it is determined whether the signature is a valid signature. If so, then at operation 310 it is determined whether the claims are valid. If so, then at operation 312 access is granted to the file. If either the checks at operation 308 or operation 310 fail, then access to the file is denied for the user at operation 314.

If at operation 306 it is determined that the header does not the certificate chain of the data lake file management software, then the web token is a recipient web token. At operation 316, it is determined whether the signature is a valid signature. If so, then at operation 318 it is determined whether the claims are valid. If so, then at operation 320, privileges of an issuer of the recipient web token are extracted based on static authorization records of a CFC. At operation 322, it is determined if the privileges of the user are enough to access the file. If not, then at operation 314 the access is denied. Otherwise, at operation 312 the access is granted.

In view of the above-described implementations of subject matter, this application discloses the following list of examples, wherein one feature of an example in isolation or more than one feature of said example taken in combination and, optionally, in combination with one or more features of one or more further examples are further examples also falling within the disclosure of this application:

Example 1 is a system comprising: at least one hardware processor; and a computer-readable medium storing instructions that, when executed by the at least one hardware processor, cause the at least one hardware processor to perform operations comprising: receiving, from a user, a request to access a file stored in a data lake; receiving a web token associated with the user, the web token containing a header, a signature, and one or more Examples; determining whether the header contains a certificate chain of the software used to access files in the data lake; in response to a determination that the header contains the certificate chain of the software used to access files in the data lake, determining whether the signature is a valid signature; in response to a determination that the signature is a valid signature, determining whether the claims are valid; and in response to a determination that the claims are valid, granting access, to the user, to the file.

In Example 2, the subject matter of Example 1 comprises, wherein the operations further comprise: in response to a determination that the header does not contain a certificate chain of the software used to access files in the data lake, identifying the web token as a recipient web token determining whether the signature of the recipient web token is a valid signature; in response to a determination that the signature of the web token is a valid signature, determining whether the Examples of the recipient web token are valid; and in response to a determination that the claims of the recipient web token are valid, extracting privileges of an issuer of the recipient web token based on static authorization records of a content filtering client (CFC).

In Example 3, the subject matter of Examples 1-2 comprises, wherein the web token is an internal web token and access to the file is restricted based on whether the web token is trusted by an internal trust store.

In Example 4, the subject matter of Examples 2-3 comprises, wherein access to the file is restricted based on whether the web token is trusted by a CFC-specific trust store.

In Example 5, the subject matter of Examples 1-4 comprises, wherein the one or more Examples comprise privileges assigned for the user for specific resources.

In Example 6, the subject matter of Examples 1-5 comprises, wherein the one or more Examples comprises constraints restricting usage of the web token.

In Example 7, the subject matter of Examples 1-6 comprises, wherein the one or more Examples comprise an audience claim, the audience claim describing data lake instances in which the web token can be used.

Example 8 is a method comprising: receiving, from a user, a request to access a file stored in a data lake; receiving a web token associated with the user, the web token containing a header, a signature, and one or more Examples; determining whether the header contains a certificate chain of software used to access files in the data lake; in response to a determination that the header contains the certificate chain of the software used to access files in the data lake, determining whether the signature is a valid signature; in response to a determination that the signature is a valid signature, determining whether the claims are valid; and in response to a determination that the claims are valid, granting access, to the user, to the file.

In Example 9, the subject matter of Example 8 comprises, in response to a determination that the header does not contain a certificate chain of the software used to access files in the data lake, identifying the web token as a recipient web token determining whether the signature of the recipient web token is a valid signature; in response to a determination that the signature of the web token is a valid signature, determining whether the Examples of the recipient web token are valid; and in response to a determination that the claims of the recipient web token are valid, extracting privileges of an issuer of the recipient web token based on static authorization records of a content filtering client (CFC).

In Example 10, the subject matter of Examples 8-9 comprises, wherein the web token is an internal web token and access to the file is restricted based on whether the web token is trusted by an internal trust store.

In Example 11, the subject matter of Example 10 comprises, wherein access to the file is restricted based on whether the web token is trusted by a CFC-specific trust store.

In Example 12, the subject matter of Examples 8-11 comprises, wherein the one or more Examples comprise privileges assigned for the user for specific resources.

In Example 13, the subject matter of Examples 8-12 comprises, wherein the one or more Examples comprises constraints restricting usage of the web token.

In Example 14, the subject matter of Examples 8-13 comprises, wherein the one or more Examples comprise an audience claim, the audience claim describing data lake instances in which the web token can be used.

Example 15 is a non-transitory machine-readable medium storing instructions which, when executed by one or more processors, cause the one or more processors to perform operations comprising: receiving, from a user, a request to access a file stored in a data lake; receiving a web token associated with the user, the web token containing a header, a signature, and one or more Examples; determining whether the header contains a certificate chain of software used to access files in the data lake; in response to a determination that the header contains the certificate chain of the software used to access files in the data lake, determining whether the signature is a valid signature; in response to a determination that the signature is a valid signature, determining whether the claims are valid; and in response to a determination that the claims are valid, granting access, to the user, to the file.

In Example 16, the subject matter of Example 15 comprises, wherein the operations further comprise: in response to a determination that the header does not contain a certificate chain of the software used to access files in the data lake, identifying the web token as a recipient web token determining whether the signature of the recipient web token is a valid signature; in response to a determination that the signature of the web token is a valid signature, determining whether the Examples of the recipient web token are valid; and in response to a determination that the claims of the recipient web token are valid, extracting privileges of an issuer of the recipient web token based on static authorization records of a content filtering client (CFC).

In Example 17, the subject matter of Examples 15-16 comprises, wherein the web token is an internal web token and access to the file is restricted based on whether the web token is trusted by an internal trust store.

In Example 18, the subject matter of Examples 16-17 comprises, wherein access to the file is restricted based on whether the web token is trusted by a CFC-specific trust store.

In Example 19, the subject matter of Examples 15-18 comprises, wherein the one or more Examples comprise privileges assigned for the user for specific resources.

In Example 20, the subject matter of Examples 15-19 comprises, wherein the one or more Examples comprises constraints restricting usage of the web token.

Example 21 is at least one machine-readable medium comprising instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

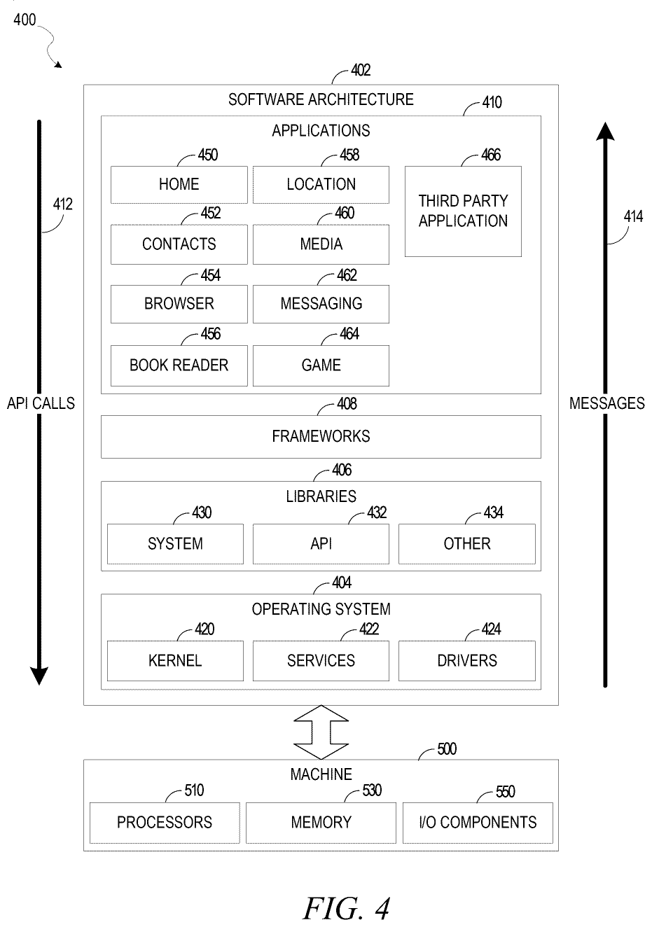

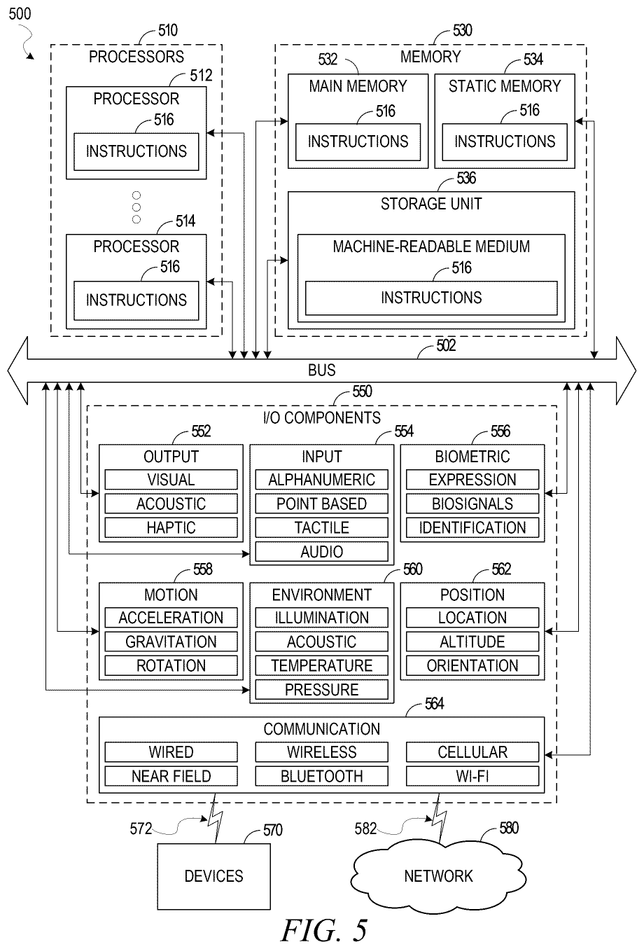

FIG. 4 is a block diagram 400 illustrating a software architecture 402, which can be installed on any one or more of the devices described above. FIG. 4 is merely a non-limiting example of a software architecture, and it will be appreciated that many other architectures can be implemented to facilitate the functionality described herein. In various embodiments, the software architecture 402 is implemented by hardware such as a machine 500 of FIG. 5 that includes processors 510, memory 530, and input/output (I/O) components 550. In this example architecture, the software architecture 402 of FIG. 4 can be conceptualized as a stack of layers where each layer may provide a particular functionality. For example, the software architecture 402 includes layers such as an operating system 404, libraries 406, frameworks 408, and applications 410. Operationally, the applications 410 invoke Application Program Interface (API) calls 412 through the software stack and receive messages 414 in response to the API calls 412, consistent with some embodiments.

In various implementations, the operating system 404 manages hardware resources and provides common services. The operating system 404 includes, for example, a kernel 420, services 422, and drivers 424. The kernel 420 acts as an abstraction layer between the hardware and the other software layers, consistent with some embodiments. For example, the kernel 420 provides memory management, processor management (e.g., scheduling), component management, networking, and security settings, among other functionalities. The services 422 can provide other common services for the other software layers. The drivers 424 are responsible for controlling or interfacing with the underlying hardware. For instance, the drivers 424 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 406 provide a low-level common infrastructure utilized by the applications 410. The libraries 406 can include system libraries 430 (e.g., C standard library) that can provide functions such as memory allocation functions, string manipulation functions, mathematic functions, and the like. In addition, the libraries 406 can include API libraries 432 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two-dimensional (2D) and three-dimensional (3D) in a graphic context on a display), database libraries (e.g., SQLite to provide various relational database functions), web libraries (e.g., WebKit to provide web browsing functionality), and the like. The libraries 406 can also include a wide variety of other libraries 434 to provide many other APIs to the applications 410.

The frameworks 408 provide a high-level common infrastructure that can be utilized by the applications 410. For example, the frameworks 408 provide various graphical user interface (GUI) functions, high-level resource management, high-level location services, and so forth. The frameworks 408 can provide a broad spectrum of other APIs that can be utilized by the applications 410, some of which may be specific to a particular operating system 404 or platform.

In an example embodiment, the applications 410 include a home application 450, a contacts application 452, a browser application 454, a book reader application 456, a location application 458, a media application 460, a messaging application 462, a game application 464, and a broad assortment of other applications, such as a third-party application 466. The applications 410 are programs that execute functions defined in the programs. Various programming languages can be employed to create one or more of the applications 410, structured in a variety of manners, such as object-oriented programming languages (e.g., Objective-C, Java, or C++) or procedural programming languages (e.g., C or assembly language). In a specific example, the third-party application 466 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 466 can invoke the API calls 412 provided by the operating system 404 to facilitate functionality described herein.

FIG. 5 illustrates a diagrammatic representation of a machine 500 in the form of a computer system within which a set of instructions may be executed for causing the machine 500 to perform any one or more of the methodologies discussed herein. Specifically, FIG. 5 shows a diagrammatic representation of the machine 500 in the example form of a computer system, within which instructions 516 (e.g., software, a program, an application, an applet, an app, or other executable code) for causing the machine 500 to perform any one or more of the methodologies discussed herein may be executed. For example, the instructions 516 may cause the machine 500 to execute the method of FIG. 3. Additionally, or alternatively, the instructions 516 may implement FIGS. 1-3 and so forth. The instructions 516 transform the general, non-programmed machine 500 into a particular machine 500 programmed to carry out the described and illustrated functions in the manner described. In alternative embodiments, the machine 500 operates as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 516, sequentially or otherwise, that specify actions to be taken by the machine 500. Further, while only a single machine 500 is illustrated, the term “machine” shall also be taken to include a collection of machines 500 that individually or jointly execute the instructions 516 to perform any one or more of the methodologies discussed herein.

The machine 500 may include processors 510, memory 530, and I/O components 550, which may be configured to communicate with each other such as via a bus 502. In an example embodiment, the processors 510 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 512 and a processor 514 that may execute the instructions 516. The term “processor” is intended to include multi-core processors that may comprise two or more independent processors (sometimes referred to as “cores”) that may execute instructions 516 contemporaneously. Although FIG. 5 shows multiple processors 510, the machine 500 may include a single processor 512 with a single core, a single processor 512 with multiple cores (e.g., a multi-core processor 512), multiple processors 512, 514 with a single core, multiple processors 512, 514 with multiple cores, or any combination thereof.

The memory 530 may include a main memory 532, a static memory 534, and a storage unit 536, each accessible to the processors 510 such as via the bus 502. The main memory 532, the static memory 534, and the storage unit 536 store the instructions 516 embodying any one or more of the methodologies or functions described herein. The instructions 516 may also reside, completely or partially, within the main memory 532, within the static memory 534, within the storage unit 536, within at least one of the processors 510 (e.g., within the processor's cache memory), or any suitable combination thereof, during execution thereof by the machine 500.

The I/O components 550 may include a wide variety of components to receive input, provide output, produce output, transmit information, exchange information, capture measurements, and so on. The specific I/O components 550 that are included in a particular machine will depend on the type of machine. For example, portable machines such as mobile phones will likely include a touch input device or other such input mechanisms, while a headless server machine will likely not include such a touch input device. It will be appreciated that the I/O components 550 may include many other components that are not shown in FIG. 5. The I/O components 550 are grouped according to functionality merely for simplifying the following discussion, and the grouping is in no way limiting. In various example embodiments, the I/O components 550 may include output components 552 and input components 554. The output components 552 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 554 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the 1/O components 550 may include biometric components 556, motion components 558, environmental components 560, or position components 562, among a wide array of other components. For example, the biometric components 556 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 558 may include acceleration sensor components (e.g., accelerometer), gravitation sensor components, rotation sensor components (e.g., gyroscope), and so forth. The environmental components 560 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 562 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 550 may include communication components 564 operable to couple the machine 500 to a network 580 or devices 570 via a coupling 582 and a coupling 572, respectively. For example, the communication components 564 may include a network interface component or another suitable device to interface with the network 580. In further examples, the communication components 564 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 570 may be another machine or any of a wide variety of peripheral devices (e.g., coupled via a USB).

Moreover, the communication components 564 may detect identifiers or include components operable to detect identifiers. For example, the communication components 564 may include radio-frequency identification (RFID) tag reader components, NFC smart tag detection components, optical reader components (e.g., an optical sensor to detect one-dimensional bar codes such as Universal Product Code (UPC) bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 564, such as location via Internet Protocol (IP) geolocation, location via Wi-Fi® signal triangulation, location via detecting an NFC beacon signal that may indicate a particular location, and so forth.

The various memories (i.e., 530, 532, 534, and/or memory of the processor(s) 510) and/or the storage unit 536 may store one or more sets of instructions 516 and data structures (e.g., software) embodying or utilized by any one or more of the methodologies or functions described herein. These instructions (e.g., the instructions 516), when executed by the processor(s) 510, cause various operations to implement the disclosed embodiments.

As used herein, the terms “machine-storage medium,” “device-storage medium,” and “computer-storage medium” mean the same thing and may be used interchangeably. The terms refer to single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 580 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 580 or a portion of the network 580 may include a wireless or cellular network, and the coupling 582 may be a Code Division Multiple Access (CDMA) connection, a Global System for Mobile communications (GSM) connection, or another type of cellular or wireless coupling. In this example, the coupling 582 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 516 may be transmitted or received over the network 580 using a transmission medium via a network interface device (e.g., a network interface component included in the communication components 564) and utilizing any one of several well-known transfer protocols (e.g., HTTP). Similarly, the instructions 516 may be transmitted or received using a transmission medium via the coupling 572 (e.g., a peer-to-peer coupling) to the devices 570. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 516 for execution by the machine 500, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
at least one hardware processor; and
a computer-readable medium storing instructions that, when executed by the at least one hardware processor, cause the at least one hardware processor to perform operations comprising:
receiving, from a user, a request to access a file stored in a data lake;
receiving a web token associated with the user, the web token containing a header, a signature, and one or more claims;
determining whether the header contains a certificate chain of software used to access files in a data lake;
in response to a determination that the header contains the certificate chain of the software used to access files in a data lake, determining whether the signature is a valid signature;
in response to a determination that the signature is a valid signature, determining whether the claims are valid; and
in response to a determination that the claims are valid, granting access, to the user, to the file.

2. The system of claim 1, wherein the operations further comprise:
in response to a determination that the header does not contain a certificate chain of the software used to access files in the data lake, identifying the web token as a recipient web token;
determining whether the signature of the recipient web token is a valid signature;
in response to a determination that the signature of the web token is a valid signature, determining whether the claims of the recipient web token are valid; and
in response to a determination that the claims of the recipient web token are valid, extracting privileges of an issuer of the recipient web token based on static authorization records of a content filtering client (CFC).

3. The system of claim 1, wherein the web token is an internal web token and access to the file is restricted based on whether the web token is trusted by an internal trust store.

4. The system of claim 2, wherein access to the file is restricted based on whether the web token is trusted by a CFC-specific trust store.

5. The system of claim 1, wherein the one or more claims comprise privileges assigned for the user for specific resources.

6. The system of claim 1, wherein the one or more claims comprises constraints restricting usage of the web token.

7. The system of claim 1, wherein the one or more claims comprise an audience claim, the audience claim describing data lake instances in which the web token can be used.

8. A method comprising:
receiving, from a user, a request to access a file stored in a data lake;
receiving a web token associated with the user, the web token containing a header, a signature, and one or more claims;
determining whether the header contains a certificate chain of software used to access files in the data lake;
in response to a determination that the header contains the certificate chain of the software used to access files in the data lake, determining whether the signature is a valid signature;
in response to a determination that the signature is a valid signature, determining whether the claims are valid; and
in response to a determination that the claims are valid, granting access, to the user, to the file.

9. The method of claim 8, further comprising:
in response to a determination that the header does not contain a certificate chain of the software used to access files in the data lake, identifying the web token as a recipient web token;
determining whether the signature of the recipient web token is a valid signature;
in response to a determination that the signature of the web token is a valid signature, determining whether the claims of the recipient web token are valid; and
in response to a determination that the claims of the recipient web token are valid, extracting privileges of an issuer of the recipient web token based on static authorization records of a content filtering client (CFC).

10. The method of claim 8, wherein the web token is an internal web token and access to the file is restricted based on whether the web token is trusted by an internal trust store.

11. The method of claim 10, wherein access to the file is restricted based on whether the web token is trusted by a CFC-specific trust store.

12. The method of claim 8, wherein the one or more claims comprise privileges assigned for the user for specific resources.

13. The method of claim 8, wherein the one or more claims comprises constraints restricting usage of the web token.

14. The method of claim 8, wherein the one or more claims comprise an audience claim, the audience claim describing data lake instances in which the web token can be used.

15. A non-transitory machine-readable medium storing instructions which, when executed by one or more processors, cause the one or more processors to perform operations comprising:
receiving, from a user, a request to access a file stored in a data lake;
receiving a web token associated with the user, the web token containing a header, a signature, and one or more claims;
determining whether the header contains a certificate chain of software used to access files in the data lake;
in response to a determination that the header contains the certificate chain of the software used to access files in the data lake, determining whether the signature is a valid signature;
in response to a determination that the signature is a valid signature, determining whether the claims are valid; and
in response to a determination that the claims are valid, granting access, to the user, to the file.

16. The non-transitory machine-readable medium storing of claim 15, wherein the operations further comprise:
in response to a determination that the header does not contain a certificate chain of the software used to access files in the data lake, identifying the web token as a recipient web token;
determining whether the signature of the recipient web token is a valid signature;
in response to a determination that the signature of the web token is a valid signature, determining whether the claims of the recipient web token are valid; and
in response to a determination that the claims of the recipient web token are valid, extracting privileges of an issuer of the recipient web token based on static authorization records of a content filtering client (CFC).

17. The non-transitory machine-readable medium storing of claim 15, wherein the web token is an internal web token and access to the file is restricted based on whether the web token is trusted by an internal trust store.

18. The non-transitory machine-readable medium storing of claim 16, wherein access to the file is restricted based on whether the web token is trusted by a CFC-specific trust store.

19. The non-transitory machine-readable medium storing of claim 15, wherein the one or more claims comprise privileges assigned for the user for specific resources.

20. The non-transitory machine-readable medium storing of claim 15, wherein the one or more claims comprises constraints restricting usage of the web token.
